(19) United States
(12) Patent Application Publication
(10) Pub. No.: US 2025/0330408 A1
(43) Pub. Date: Oct. 23, 2025

(54) UNDERLAY-AWARE ROUTING IN SD-WAN NETWORKS

(71) Applicant: Cisco Technology, Inc., San Jose, CA (US)

(72) Inventors: Aditya Arun, Bengaluru (IN); Syed Arslan Ahmed, Bengaluru (IN); Amjad Inamdar, Bengaluru (IN); Ankur Bhargava, Pleasanton, CA (US); Raj Venkatesan, Mill Valley, CA (US); Ashish Sood, Cupertino, CA (US)

(21) Appl. No.: 18/639,783

(22) Filed: Apr. 18, 2024

(51) Int. Cl. H04L 43/10

(52) U.S. Cl. CPC H04L 43/10

(57) ABSTRACT

This disclosure describes techniques for determining paths for routing traffic based on underlay attributes, where the paths may avoid and/or include certain underlay attributes. An edge device of an SD-WAN may detect underlay hops included in underlay paths by performing a path trace between the edge device and a remote device, and may send underlay path trace data to an SD-WAN underlay analytic service. The SD-WAN underlay analytic service may determine attributes associated with the underlay hops, such as the geolocation and/or an ISP associated with an underlay hop. The SD-WAN analytic service may also receive network manager policy data indicating undesirable attributes and/or preferred attributes. Accordingly, the SD-WAN may send an underlay-aware policy indicating the undesirable attributes and/or preferred attributes to the edge device, where the edge device may route entity traffic through an underlay path such that the undesirable attributes are avoided and/or the preferred attributes are included.

### TECHNICAL FIELD

The present disclosure relates generally to the field of computer networking, and more particularly to determining underlay-aware routing policies to route packets through paths that avoid undesirable attributes and/or include preferred attributes.

### BACKGROUND

Computer networks are generally a group of computers or other devices that are communicatively connected to use one or more communication protocols to exchange data. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Enterprise Networks that are built for a large organization, Internet Service Provider (ISP) networks that operate WANs to provide connectivity to individual users or enterprises, software-defined networks (SDNs), wireless networks, core networks, cloud networks, software-defined WANs (SD-WANs), and so forth.

More recently, SD-WANs have been introduced to help make WAN architectures easier to deploy, operate, and manage. SD-WAN technologies utilize virtualization, application-aware policies and overlay networks, and software platforms to increase data-transfer efficiencies across WANs by moving traffic to lower-cost network links to do the work of more expensive leased lines. Various WAN and SD-WAN technologies are used to communicate data packets between devices and across WANs. For instance, these technologies include packet switching methods, Transport Control Protocol (TCP), Internet Protocol (IP), overlay networks, Multiprotocol Label Switching (MPLS) techniques, and/or the like. Using these technologies, a first router can connect a first LAN over a WAN with a second router located within a second LAN.

SD-WANs also create efficiencies as in an SD-WAN, overlay-based tunnels between endpoints may be created over any type of WAN transport (e.g., public transports such as the Internet, private transports, 3G networks, 4G networks, and the like). The use of overlay-based tunnels may enable network segmentation at large scales as well as flexibility. However, SD-WANs also create additional layers of network abstraction. Accordingly, while the overlay-based tunnels of SD-WANs can create flexibility on the types of transports used as well as other efficiencies, there is a loss of visibility with respect to certain attributes of the underlay network (e.g., underlay WAN network types, number of underlay hops, etc.). Because of this loss of visibility, entities (e.g., enterprises, users, etc.) are unable to control the underlay hops through which their traffic traverses (e.g., specific ISP networks, specific regions, and/or the like). However, there may be some instances where an entity may wish to choose their overlay paths, and in turn avoid certain regions and/or ISP networks, for security and/or optimization reasons. Additionally, or alternatively, an entity may wish to choose their overlay paths to include preferred regions and/or ISP networks.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an example environment for routing data based on an underlay-aware policy, according to at least some examples.

FIG. 2 illustrates a diagram of components the system of FIG. 1 for using underlay-aware policies based on SD-WAN underlay attributes and routing traffic based on the policy, according to at least some examples.

FIG. 3 illustrates an example environment in which an underlay-aware policy may be used to determine a path through which to route traffic, according to at least some examples.

FIG. 4 illustrates a flow diagram of an example method for collecting network metrics for underlay path hops, and routing traffic pursuant to a policy based on underlay attributes, according to at least some examples.

FIG. 5 illustrates a flow diagram of an example method for using SD-WAN underlay attributes for underlay-aware routing decisions, according to at least some examples.

FIG. 6 illustrates a computing system diagram illustrating a configuration for a data center that can be utilized to implement aspects of the technologies disclosed herein.

FIG. 7 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques for determining paths for routing traffic based on underlay attributes, where the paths may avoid undesirable underlay attributes and/or include preferred underlay attributes. A method to perform the techniques described herein at least in part by an edge device of a software-defined wide area network (SD-WAN) include enabling, at the edge device, a path trace of underlay paths between the edge device and a remote device. Additionally, or alternatively, the method includes sending, from the edge device and to a control plane, underlay path trace data. Further, the method includes receiving, from the control plane, a policy indicating segments of the underlay paths that are associated with an attribute for an entity associated with the edge device. The method may further include determining whether the attribute indicates that the segments of the underlay paths are to be avoided or included in a first underlay path. Additionally, or alternatively, the method may include in response to the attribute indicating that the segments are to be avoided, identifying the first underlay path for sending data on behalf of the entity associated with the edge device such that the segments of the underlay paths that are associated with the attribute are avoided, or in response to the attribute indicating that the segments are to be included, identifying the first underlay path for sending data on behalf of the entity associated with the edge device such that the segments of the underlay paths that are associated with the attribute are included. Further, the method may include routing data of behalf of the entity through the first underlay path.

Additionally, or alternatively, the method includes receiving, at a control plane, underlay path trace data associated with a path trace of underlay paths between an edge device and a remote device. The method may further include using the underlay path trace data, determining attributes associated with portions of the underlay paths. Further, the method includes determining, based at least in part on the attributes associated with portions of the underlay paths, a policy indicating one or more portions of the underlay paths that are associated with an attribute for an entity associated with the edge device. Additionally, or alternatively, the method includes sending the policy to the edge device.

Additionally, the techniques described herein may be performed by a system and/or device having non-transitory computer-readable media storing computer-executable instructions that, when executed by one or more processors, performs the method described above.

### EXAMPLE EMBODIMENTS

This disclosure describes techniques for determining paths for routing traffic based on underlay attributes, where the paths may avoid undesirable underlay attributes and/or include preferred underlay attributes. As discussed above, there are several limitations in the use of SD-WANs and overlay-based tunnels. Traditionally, SD-WANs allow for the use of any type of WAN transport. However, in light of the flexibility that SD-WANs and the overlay-based tunnels may provide, there is a loss of visibility of certain attributes of the underlay network due to the additional layers of network abstraction. As such, entities are unable to control the underlay hops (e.g., network segments, portions, etc.) through which their traffic traverses. In some instances, entities may wish to choose their overlay paths, and in turn, avoid and/or include certain regions and/or ISP networks, for security and/or optimization reasons.

According to the techniques described herein, one or more network devices, such as a network edge device, associated with a network, such as an SD-WAN, may be configured to communicate on behalf of different types of client devices (or other computing devices). Additionally, or alternatively, the network edge device may be configured to detect hops across multiple paths, and/or portions of the multiple paths, that may be present in the network for communicating traffic between the edge device and a remote device. In some instances, the network edge device may be configured to send probes periodically or continuously to collect underlay path trace data associated with the multiple paths and their respective hops. In some instances, the network edge device may be communicatively coupled to a controller associated with the SD-WAN to send the underlay path trace data. The network edge device may send the underlay path trace data periodically or continuously. In some instances, the underlay path trace data may include data such as round-trip-time (RTT), packet loss, latency, available bandwidth, jitter, time-to-live (TTL), and/or other characteristics indicative of network performance. The underlay path trace data may be timestamped based on when the underlay path trace data was generated, and the edge device may send the underlay path trace data, timestamp data, and/or geolocation data indicating a geolocation of the edge device.

In some instances, the controller may be associated with an underlay analytic service, where the underlay analytic service may be configured to analyze the underlay path trace data, timestamp data, and/or geolocation data indicating the geolocation of the edge device to determine one or more attributes associated with the hops of the network paths. For example, the underlay analytic service may perform geolocation techniques to determine the geolocation of the hops of the network, reverse ISP lookup, and/or other types of analytics. Based on the analytics, the controller may be configured to determine certain underlay attributes, such as intermediate ISPs and/or the geolocation of the hops. In such examples, the underlay analytic service, based on the analytics, may be able to determine the geographic location and/or the ISPs that network traffic may go through when being sent over an overlay tunnel. Additionally, or alternatively, the controller may use, or work in combination with, the edge device to determine other types of attributes associated with the network based on underlay path trace data, timestamp data, geolocation data, and/or the like. For instance, the underlay analytic service may be configured to identify geographic locations, or regions, that may be high-risk for network traffic. In some examples, a particular region may be considered high-risk for an entity (e.g., in terms of security, reliability, and/or availability), or may be considered high-risk based on regulations. Similarly, the underlay analytic service may be configured to identify high-risk ISPs. Additionally, or alternatively, the underlay analytic service may be configured to identify hotspots, outages, and/or usage patterns associated with the hops of one or more tunnels of the network.

In some instances, the controller may be associated with and/or communicatively coupled to a network manager associated with an enterprise, entity, etc. In this way, the controller may receive user input (e.g., policy data) associated with the network manager and indicating desirable and/or undesirable attributes associated with the path through which the network manager intends entity traffic to traverse. For example, the policy data may indicate an intent to route traffic through a path that is compliant with a service level agreement (SLA) value, traverses through a hop in Los Angeles, California, and/or traverses through a particular ISP. Additionally, or alternatively, the policy data may indicate an intent to route traffic through a path that is compliant with the SLA value, avoids traversing through a hop in Seattle, Washington, and/or avoids traversing through the particular ISP. In some instances, the policy data may indicate an intent to generally route traffic through a path that avoids hotspots, outages, and/or high-risk regions.

Based on the attributes determined by the underlay analytic service and the policy data associated with a network manager, the SD-WAN controller may be configured to send an underlay-aware policy to the edge device for routing traffic through a path of the network, wherein the underlay-aware policy may indicate the attributes determined by the underlay analytic service and/or the policy data of the network manager. In some instances, the SD-WAN controller and/or the underlay analytic service may be configured to associate the attributes determined by the underlay analytic service and the policy data of the network manager, and send the association as an underlay-aware policy to a network device. For example, the underlay-aware policy may indicate the attributes associated with the hops that are to be included in the tunnel for routing traffic. Additionally, or alternatively, the underlay-aware policy may indicate the attributes associated with the hops that are to be avoided and/or undesirable in the tunnel for routing traffic. In some instances, the underlay-aware policy may indicate the attributes associated with the hops that are to be included and/or preferred in the tunnel for routing traffic. The underlay-aware policy may then be sent to the edge device. Upon receiving the underlay-aware policy, the edge device may route the traffic associated with the entity through overlay tunnels and in accordance with the policy.

Although the techniques are described as being implemented using a cloud service, including computing servers, data centers, and/or a cloud computing network, the techniques are generally applicable for any network of devices managed by an entity where virtual resources may be provisioned. In some instances, various components may be used in a system to perform the techniques described herein. The devices and components by which the techniques are performed are a matter of implementation, and the techniques described are not limited to any specific architecture or implementation.

The techniques described herein provide various improvements and efficiencies with respect to using an underlay analytic service to identify attributes associated with an SD-WAN underlay. For example, the techniques described herein may allow for the determination of one or more tunnels of a SD-WAN for routing traffic based on an underlay-aware policy indicating attributes associated with the underlay of the SD-WAN, where undesirable attributes may be avoided and/or preferred attributes may be included. The techniques may allow for path tracing of underlay paths associated with an SD-WAN to determine underlay path trace data. Attributes associated with the underlay paths, such as geolocation of hops in a path and/or ISPs in a path, may be determined based on the underlay path trace data. Additionally, or alternatively, an underlay-aware policy indicating an association between the attributes and the policy data associated with the network manager may be sent to a network device from the SD-WAN controller, where an entity may be able to selectively route their traffic through a tunnel based on attributes they intend to be included in the tunnel and/or undesirable attributes they intend to be avoided. The underlay-aware policy may be dynamically updated as network conditions change.

Certain implementations and embodiments of the disclosure will now be described more fully with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

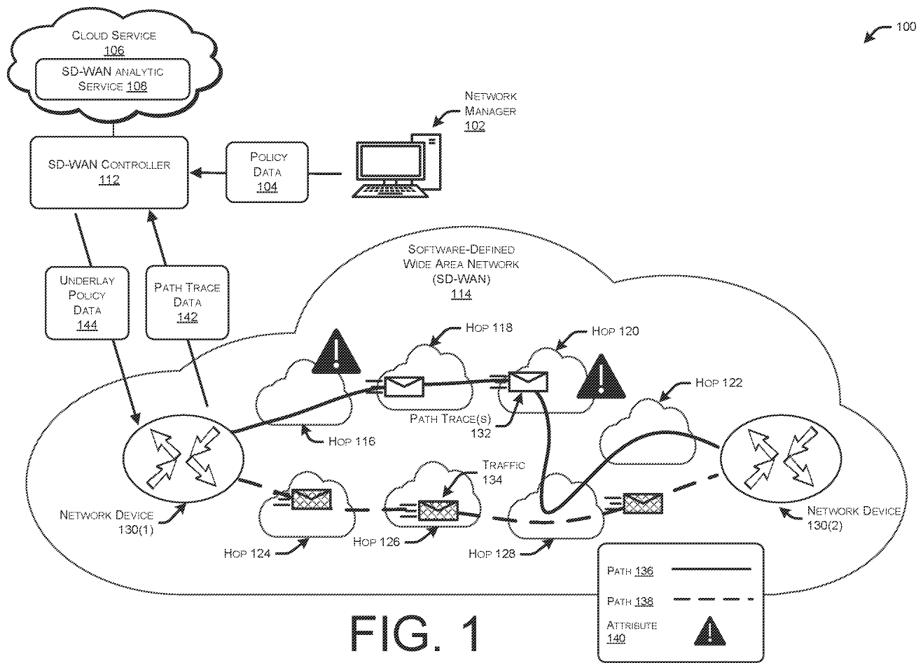

FIG. 1 illustrates a system-architecture diagram of an example environment 100 for routing data based on an underlay-aware policy indicating underlay attributes, according to at least some examples. The environment 100 includes an SD-WAN controller for receiving path trace data 142 and a cloud service 106 for analyzing the path trace data 142 and identifying underlay attributes. This way, network device(s) 130 may route traffic on behalf of an entity in accordance with an underlay-aware policy provided by the SD-WAN analytic service 108 and/or SD-WAN controller 112 and indicating underlay attributes that are to be included and/or avoided when routing traffic.

Network device 130(1) and/or network device 130(2) may be associated with SD-WAN 114, and may be configured to communicate on behalf of different types of client devices. The network manager 102 may be associated with an entity, user(s), and/or the like. The network manager 102 may comprise any type of electronic device capable of communicating using various communication protocols (e.g., short range protocols, TCP/IP, User Datagram Protocol (UDP), tunneling protocols, and/or any other protocol) over various networks. For instance, the network manager 102 may include one or more of different personal user devices, such as desktop computers, laptop computers, phones, tablets, wearable devices, entertainment devices such as televisions, network devices (e.g., servers, routers, switches, access points, etc.) and/or any other type of computing device.

The SD-WAN 114 may include one or more networks implemented by any viable communication technology, such as wired and/or wireless modalities and/or technologies. The SD-WAN 114 may include or connect any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)-both centralized and/or distributed- and/or any combination, permutation, and/or aggregation thereof. The SD-WAN 114 may include devices, such as network devices 130, virtual resources, or other nodes that relay traffic from one network segment to another by nodes in the computer network.

In some instances, a network edge device, such as network device 130(1) may be configured to detect hops across multiple paths, such as path 136 and/or 138, that may be present in the SD-WAN 114 for communicating traffic 134. The network device 130(1) may collect path trace data 142 associated with the SD-WAN that may indicate a detection of one or more hops included in the multiple paths. For example, the network device 130(1) may be configured to send path trace(s) 132 (e.g., probes) periodically or continuously to collect path trace data 142 associated with the multiple paths and their respective hops (e.g., routers, intermediary devices, etc.) between the network device 130(1) and/or network device 130(2). For example, the network device 130(1) may send path trace(s) 132 through path 136 and/or 138 in order to collect path trace data 142. In some instances, the path trace data 142 may include data such as round-trip-time (RTT), packet loss, latency, available bandwidth, jitter, time-to-live (TTL), and/or other characteristics indicative of network performance. The path trace data 142 may be timestamped based on when the path trace data 142 was generated, and the network device 130(1) may send the path trace data 142, timestamp data, and/or geolocation data indicating a geolocation of the network device 130(1). Additionally, or alternatively, the path trace data 142 may include an indication of the detected hops in the SD-WAN 114. For example, path 136 may include hops 116, 118, 120, and/or 122. Additionally, or alternatively, path 138 may include hops 124, 126, and/or 128. In some instances, the path trace data 142 may include an indication of the Internet Protocol addresses (IP addresses) associated with the hops. After the network device 130(1) has sent path trace(s) 132 and has collected path trace data 142 associated with the path 136 and/or the path 138, the network device 130(1) may be configured to send the path trace data 142 to the SD-WAN controller 112.

In some instances, the controller 112 may be associated with a cloud service 106. The cloud service 106 may provide one or more SD-WAN analytic services 108 to entities associated with the network manager 102 that are configured to communicate over one or more SD-WANs 114. The cloud service 106 may comprise one or more components, subcomponents, and/or configurations. For example, the cloud service 106 may include SD-WAN analytic service 108, which may be configured to determine underlay attributes of the SD-WAN 114 and send an underlay-aware policy for the network device 130(1) for routing traffic 134. In some examples, the cloud service 106 may be or comprise a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the cloud service 106 may be an on-premises network, a private network of a corporation, and/or any other type of network or combination thereof.

In some instances, SD-WAN analytic service 108 may be a scalable service that includes and/or runs on devices housed or located in one or more data centers, that may be located at different physical locations. In some examples, the SD-WAN analytic service 108 may be supported by networks of devices in a public cloud computing platform, a private/enterprise computing platform, and/or any combination thereof. The one or more data centers may be physical facilities or buildings located across geographic areas that are designated to store network devices that are part of and/or support the SD-WAN analytic service 108. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as process (CPU), memory (RAM), storage (disk), and networking (bandwidth).

In some instances, the SD-WAN controller 112 may use, or work in conjunction with, the SD-WAN analytic service 108 in order to identify underlay attributes associated with the hops detected by the network device 130(1). In some instances, the SD-WAN analytic service 108 may be configured to analyze the path trace data 142, including time stamp data and/or geolocation data indicating the geolocation of the edge device to determine one or more attributes associated with the hops in the SD-WAN 114. In some instances, the SD-WAN analytic service 108 may perform geolocation techniques to determine the geolocation of the hops of the SD-WAN 114. The SD-WAN analytic service 108 may be configured to perform a geolocation lookup based on IP addresses included in the path trace data 142, and/or other types of path trace data 142, to determine the geolocation (e.g., coordinates, city, region, country, etc.) of the hops of the SD-WAN 114. For example, the SD-WAN analytic service 108 may determine that hop 116 and hop 124 are in a first region, hop 118 and hop 126 are in a second region, hop 120 and hop 128 are in a third region, and/or hop 122 is in a fourth region. Additionally, or alternatively, the SD-WAN analytic service 108 may determine, using reverse ISP lookup techniques, the particular ISP associated with each hop. The SD-WAN analytic service 108 may be configured to perform a reverse lookup based on IP addresses included in the path trace data 142, and/or or other types of path trace data 142, to determine the ISPs associated with the hops of the SD-WAN 114. By way of example, and not limitation, hop 116 may be associated with an ISP XXX, hop 118 may be associated with an IP YYY, hop 120 may be associated with an ISP ZZZ, and so on.

The SD-WAN analytic service 108 may also be configured to determine other types of attributes associated with the SD-WAN 114 based on the path trace data 142 (e.g., hot spots, high-risk regions, historical usage patterns, and/or the like). For instance, the SD-WAN analytic service 108 may be configured to identify geographic locations, or regions, that may be high-risk for network traffic 134. In some examples, a particular region may be considered high-risk for the entity associated with the network manager 102. In some examples, a particular region may be considered high-risk for an entity (e.g., in terms of security, reliability, and/or availability), or may be considered high-risk based on regulations. As a non-limiting example, the SD-WAN analytic service 108 may determine an attribute 140 of hop 116, where the attribute 140 may include an indication that the hop 116 is located in a particular region that is considered high-risk. Similarly, the SD-WAN analytic service 108 may be configured to identify high-risk ISPs. In some examples, a particular ISP may be considered high-risk for an entity. As a non-limiting example, the SD-WAN analytic service 108 may determine an attribute 140 of hop 120, where the attribute 140 may include an indication that the hop 116 is associated with an ISP XXX that is considered high-risk for the entity associated with the network manager 102.

In some instances, the SD-WAN controller 112 may be communicatively coupled to the network manager 102 such that the SD-WAN controller 112 may receive policy data 104. This way, the SD-WAN controller 112 may receive policy data 104 associated with the entity of the network manager 102, where the policy data 104 may indicate desirable and/or undesirable attributes associated with the path through which the entity intends their traffic 134 to traverse. For example, the policy data 104 may indicate an intent to route traffic 134 through a path that is compliant with a service level agreement (SLA) value, traverses through a hop in Canada, and/or traverses through ISP XXX. Additionally, or alternatively, the policy data 104 may indicate an intent to route traffic through a path that is compliant with the SLA value, avoids traversing through a hop in Switzerland, and/or avoids traversing through ISP YYY. By way of example, and not limitation, hop 116 of SD-WAN 114 may be determined by the SD-WAN analytic service 108 as being associated with an undesirable attribute 140, where the attribute 140 indicates that the hop 116 is located in Switzerland. Additionally, or alternatively, hop 120 of SD-WAN 114 may be determined by the SD-WAN analytic service 108 as being associated with an undesirable attribute 140, where the attribute 140 indicates that the hop 120 is associated with ISP YYY. Additionally, or alternatively, the policy data 104 may indicate an intent to generally route traffic 134 through a path that avoids hotspots and/or high-risk regions.

Based on the attributes determined by the SD-WAN analytic service 108 and/or the policy data 104, the SD-WAN controller 112 may be configured to send underlay policy data 144 to the network device 130(1) in routing traffic 134 through a path of the SD-WAN 114, where the underlay policy data 144 may indicate an association determined by the SD-WAN analytic service 108 and/or SD-WAN controller 112 between the attributes and the policy data 104 of the network manager 102. For example, the underlay policy data 144 may include an indication of attributes that are to be avoided when routing traffic 134 through a path of the SD-WAN 114. Continuing from the example above, hop 116 of SD-WAN 114 may be determined by the SD-WAN analytic service 108 as being associated with an undesirable attribute 140, where the attribute 140 indicates that the hop 116 is located in Switzerland. Additionally, or alternatively, hop 120 of SD-WAN 114 may be determined by the SD-WAN analytic service 108 as being associated with an undesirable attribute 140, where the attribute 140 indicates that the hop 120 is associated with ISP YYY. As illustrated, hop 116 and hop 120 with undesirable attribute(s) 140 may be included in a path, such as path 136. Based on the undesirable attribute(s) 140 that may be indicated by the underlay policy data 144, the network device 130(1) may route traffic 134 through path 138, as path 138 may not include hop 116 and hop 120 with undesirable attribute(s) 140. Additionally, or alternatively, the underlay policy data 144 may be updated by the SD-WAN analytic service 108 in response to changes in network conditions indicated by path trace data 142 (e.g., the SD-WAN analytic service 108 determines that, based at least in part on the path trace data 142, a hop that was previously high-risk is no longer high-risk).

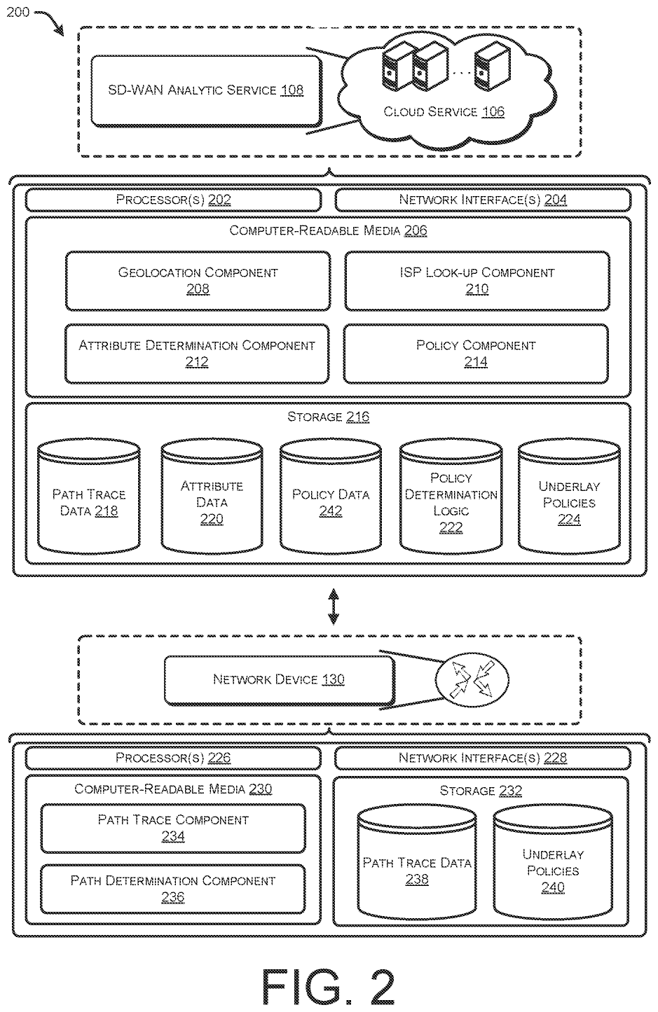

FIG. 2 illustrates an example environment 200 of example components of the SD-WAN analytic service 108 at the cloud service 106 and the network device 130. As illustrated, the cloud service 106 and/or network device 130 may include one or more hardware processor(s) 202 and/or processor(s) 226 (processors) configured to execute one or more stored instructions. The processors 202 may comprise one or more cores. Further, the cloud service 106 may include network interface(s) 204 to allow the processors 202 or other portions of the cloud service 106 to communicate with other devices. The network interface(s) 204 may comprise Inter-Integrated Circuit (I2C), Serial Peripheral Interface bus (SPI), Universal Serial Bus (USB) as promulgated by the USB Implementers Forum, RS-232, and so forth. The network interface(s) 204 may include devices configured to couple to personal area networks (PANs), wired and wireless local area networks (LANs), wired and wireless wide area networks (WANs), and so forth. For example, the network interface(s) 204 may include devices compatible with Ethernet, Wi-Fi™, and so forth.

The cloud service 106 may also include computer-readable media 206 that stores various executable components (e.g., software-based components, firmware-based components, etc.). In addition to various components discussed in FIG. 2, the computer-readable media 206 may further store components to implement functionality described herein. While not illustrated, the computer-readable media 206 may store one or more operating systems utilized to control the operation of the one or more devices that comprise the cloud service 106. The operating systems may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth.

The computer-readable media may include a geolocation component 208 that configures the SD-WAN analytic service 108 to perform various operations described herein. For instance, the geolocation component 208 may be configured to, when executed by the processors 202, perform various techniques for determining geolocation attributes associated with one or more underlay hops of an SD-WAN. The geolocation component 208 may utilize path trace data 218, which may include data such as round-trip time (RTT), packet loss, latency, available bandwidth, jitter, time-to-live (TTL), and/or other characteristics indicative of network performance, as well as timestamp data and/or geolocation data indicating a geolocation of a network device 130. The geolocation component 208 may be configured to use IP addresses included in the path trace data 218, and/or other types of path trace data 218, to determine the geolocation (e.g., coordinates, city, region, country, etc.) of the hops. The computer-readable media 206 may also include an ISP look-up component 210 that configures the SD-WAN analytic service 108 to perform various operations described herein. For instance, the ISP look-up component 210 may be configured to, when executed by the processors 202, perform various techniques for determining ISP attributes associated with one or more underlay hops of an SD-WAN.

The computer-readable media 206 may also include an attribute determination component 212 that configures the SD-WAN analytic service 108 to perform various operations described herein. For instance, the attribute determination component 212 may be configured to, when executed by the processors 202, perform various techniques for determining other types of attributes associated with the one or more underlay hops of an SD-WAN (e.g., hot spots, high-risk regions, historical usage patterns, and/or the like). The attribute determination component 212 may utilize path trace data 218, which may include data such as round-trip time (RTT), packet loss, latency, available bandwidth, jitter, time-to-live (TTL), and/or other characteristics indicative of network performance, as well as timestamp data and/or geolocation data indicating a geolocation of a network device 130.

The computer-readable media 206 may also include a policy component 214 that configures the SD-WAN analytic service 108 to perform various operations described herein. For instance, the policy component 214 may be configured to, when executed by the processors 202, perform various techniques determining and/or sending an underlay-aware policy for routing traffic based on underlay attributes. The policy component 214 may utilize data received from an entity and/or network manager, such as network manager 102, that may indicate desirable and/or undesirable attributes associated with the path through which an entity intends their traffic to traverse. Based on the attributes determined by the SD-WAN analytic service and/or the attributes, the policy determination component may be configured to determine and/or send underlay policy data to be used by the network device 130 in routing traffic through a path of an SD-WAN.

Additionally, the cloud service 106 may include storage 216 which may comprise one, or multiple, repositories or other storage locations for persistently storing and managing collections of data such as databases, simple files, binary, and/or any other data. The storage 216 may include one or more storage locations that may be managed by one or more storage/database management systems. By way of example, and not limitation, computer-readable storage media 216 can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As illustrated, the storage 216 may include path trace data 218, attribute data 220, policy data 242, policy determination logic 222, and underlay policies 224. It should be appreciated that the foregoing list is merely exemplary and the storage 216 may include additional elements that may be apparent to one skilled in the art.

The path trace data 218 may include a database of path trace data received from the network device 130. For example, the path trace data 218 may include data such as round-trip-time (RTT), packet loss, latency, available bandwidth, jitter, time-to-live (TTL), and/or other characteristics indicative of network performance. The path trace data 218 may be timestamped based on when the path trace data 218 was generated, and path trace data 218 may also include timestamp data and/or geolocation data indicating a geolocation of the network device 130.

Attribute data 220 may include a database of attributes determined by the SD-WAN analytic service 108 associated with one or more hops included in paths of an SD-WAN. For example, the attribute data 220 may include the geographic region of the hops, ISPs associated with each of the hops, hot spots, high-risk regions, historical usage patterns, and/or the like.

The policy data 242 may include a database of policy data received from an entity and/or network manager. For example, the policy data 242 may include a record of policy data that may indicate desirable and/or undesirable attributes associated with the path through which the entity intends their traffic to traverse.

The policy determination logic 222 may include a database of logic for determining underlay-aware policies and/or determining an association between underlay attributes and policies from a network manager for routing entity traffic For example, the policy component 214 may reference path trace data 218, attribute data 220, policy data 242, and/or policy determination logic 222 in determining an association between underlay attributes and policy data 242, such that an underlay-aware policy for routing traffic based on certain underlay attributes may be sent to the network device 130.

The underlay policies 224 may store the results of the policy component 214. Additionally, or alternatively, the underlay policies 224 may include a database formed as a historical compilation of policies for routing traffic based on certain underlay attributes.

The network device 130 may include network interface(s) 228 to allow the processors 226 or other portions of the network device 130 to communicate with other devices. The network interface(s) 228 may comprise Inter-Integrated Circuit (I2C), Serial Peripheral Interface bus (SPI), Universal Serial Bus (USB) as promulgated by the USB Implementers Forum, RS-232, and so forth. The network interface(s) 228 may include devices configured to couple to personal area networks (PANs), wired and wireless local area networks (LANs), wired and wireless wide area networks (WANs), and so forth. For example, the network interface(s) 228 may include devices compatible with Ethernet, Wi-Fi™, and so forth.

The network device 130 may also include computer-readable media 230 that stores various executable components (e.g., software-based components, firmware-based components, etc.). In addition to various components discussed in FIG. 2, the computer-readable media 230 may further store components to implement functionality described herein. While not illustrated, the computer-readable media 230 may store one or more operating systems utilized to control the operation of the one or more devices that comprise the cloud service 106. The operating systems may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth.

The computer-readable media 230 may include a path trace component 234 that configures the network device 130 to perform various operations described herein. For instance, the path trace component 234 may be configured to, when executed by the processors 226, perform various techniques for collecting path trace data associated with multiple paths of an SD-WAN. In some instances, the path trace component 234 may cause the network device 130 to trace the paths of multiple paths in order to detect underlay hops that may be included in one or more paths. The network device 130 may periodically or continuously trace the paths of the multiple paths.

The computer-readable media 230 may include a path determination component 236 that configures the network device 130 to perform various operations described herein. For instance, the path determination component 236 may be configured to, when executed by the processors 226, perform various techniques for routing traffic via a path of the SD-WAN based on a policy indicating underlay attributes. In some instances, based on underlay attributes that, as indicated by the policy, are to be avoided and/or included for entity traffic, the network device 130 may determine a path that would satisfy the policy (e.g., a path that does not include underlay hops associated with the undesirable attributes and/or a path that includes underlay hops associated with the preferred attributes). As such, the network device 130 may send entity traffic over the path that is in accordance with the policy.

Additionally, the network device 130 may include storage 232 which may comprise one, or multiple, repositories or other storage locations for persistently storing and managing collections of data such as databases, simple files, binary, and/or any other data. The storage 232 may include one or more storage locations that may be managed by one or more storage/database management systems. By way of example, and not limitation, computer-readable storage media 232 can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As illustrated, the storage 232 may include path trace data 238 and underlay policies 240. It should be appreciated that the foregoing list is merely exemplary and the storage 232 may include additional elements that may be apparent to one skilled in the art. The path trace data 238 may include a database of the path trace data of multiple paths in the SD-WAN, including detected underlay hops that may be included in one or more paths. Underlay policies 240 may include the results of the policy component 214 received by the network device 130. Additionally, or alternatively, the underlay policies 224 may include a database formed as a historical compilation of policies for routing traffic based on certain underlay attributes.

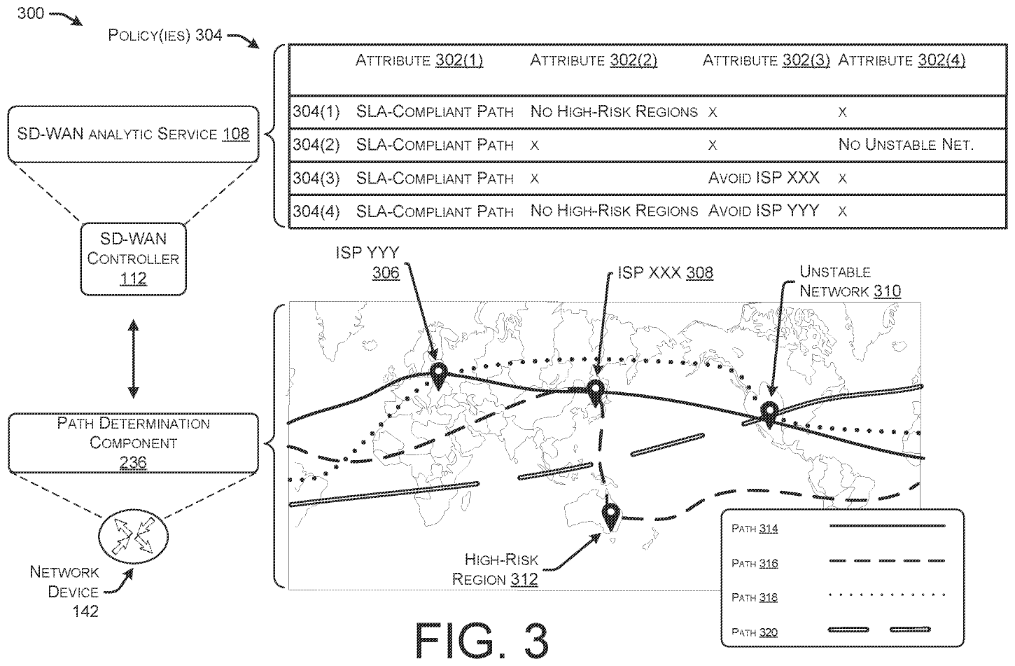

FIG. 3 illustrates an example environment 300 in which an underlay-aware policy may be used by a path determination component 236 to determine a path through which to route traffic, according to at least some examples.

As illustrated, the SD-WAN analytic service, which may be associated with SD-WAN controller 112, may determine policy (ies) 304 for routing traffic in an SD-WAN based on underlay attributes 302. As described above, the SD-WAN analytic service 108 may analyze path trace data to determine underlay attributes associated with underlay hops included in on or more paths of the SD-WAN. For example, the SD-WAN analytic service 108 may determine the region in which a hop is located, an ISP associated with a hop, and/or determine which hops are high-risk (e.g., in high-risk regions), which hops are hot spots, historical usage patterns associated with the hops, and/or the like. Additionally, or alternatively, the SD-WAN analytic service 108 may receive input and/or a policy from a network manager associated with an entity, where the input and/or policy may indicate desirable and/or undesirable attributes associated with the path through which an entity intends their traffic to traverse. The SD-WAN analytic service 108 may then determine one or more policy (ies) 304 for routing traffic through the SD-WAN based on underlay attributes 302.

As illustrated, and by way of example, and not limitation, policy 304(1) may include attribute 302(1), where the path through which traffic is to be traversed must be an SLA-compliant path. Additionally, or alternatively, policy 304(1) may include attribute 302(2), where the path through which traffic is to be traversed must avoid high-risk regions. As such, the path determination component 236 associated with network device 130 may be configured to route traffic via path 314, which is presumably an SLA-compliant path and avoids any underlay hops at high-risk region 312. Additionally, or alternatively, policy 304(2) may include attribute 302(1) and/or attribute 302(4), where the path through which traffic is to be traversed must avoid unstable networks. As such, the path determination component 236 may be configured to route traffic via path 316, which is presumably an SLA-compliant path and avoids any underlay hops at unstable network 310.

Additionally, or alternatively, policy 304(3) may include attribute 302(1) and/or attribute 302(3), where the path through which traffic is to be traversed must avoid an ISP address, such as ISP XXX. As such, the path determination component 236 may be configured to route traffic via path 318, which is presumably an SLA-compliant path and avoids any underlay hops associated with ISP XXX 308. Additionally, or alternatively, policy 304(4) may include attribute 302(1), and/or attribute 302(2) to avoid high-risk regions, and/or attribute 302(3) to avoid ISP YYY. As such, the path determination component 236 may be configured to route traffic via path 320, which is presumably an SLA-compliant path, avoids any underlay hops at high-risk region 312, and avoids any underlay hops associated with ISP YYY 306.

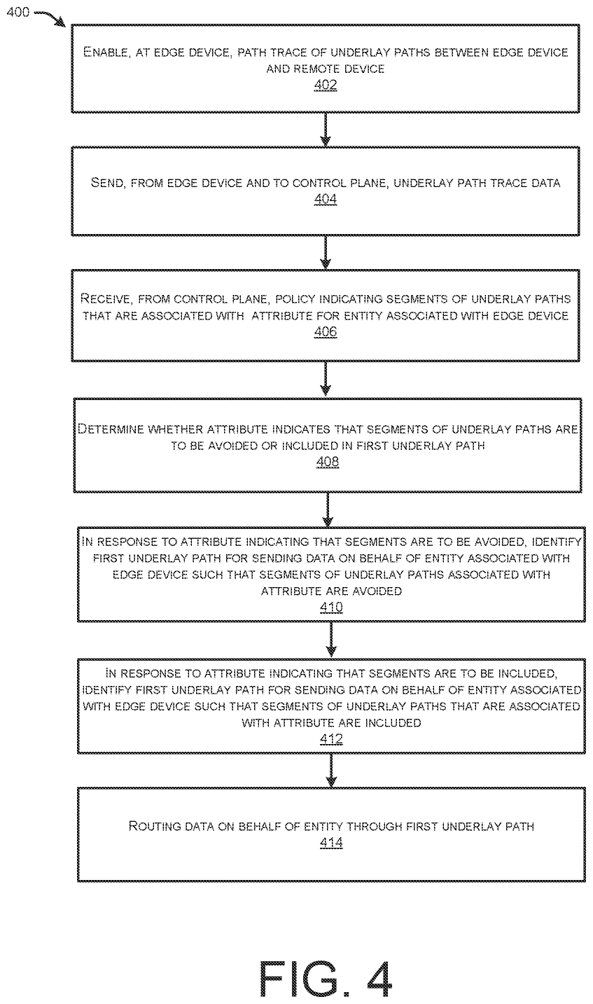

FIG. 4 illustrates a flow diagram of an example method for collecting network metrics for underlay path hops, and routing traffic pursuant to a policy based on underlay attributes, according to at least some examples. The techniques may be applied by a system comprising one or more processors, and one or more non-transitory computer-readable media storing computer-executable instructions that, when executed by the one or more processors, cause the one or more processors to perform operations of process 400.

The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures, and systems.

At block 402, the process 400 may include enabling, at the edge device, a path trace of underlay paths between the edge device and a remote device. In some instances, a network edge device, such as first network device may be configured to detect hops across multiple paths, such as a first path and/or a second path, that may be present in the SD-WAN for communicating traffic. The first network device may collect path trace data associated with the SD-WAN that may indicate a detection of one or more hops included in the multiple paths. For example, the first network device may be configured to send path trace(s) (e.g., probes) periodically or continuously to collect path trace data associated with the multiple paths and their respective hops (e.g., routers, intermediary devices, etc.) between the first network device and/or network device. In some instances, the path trace data may include data such as round-trip-time (RTT), packet loss, latency, available bandwidth, jitter, time-to-live (TTL), and/or other characteristics indicative of network performance. The path trace data may be timestamped based on when the path trace data was generated, and the first network device may send the path trace data, timestamp data, and/or geolocation data indicating a geolocation of the first network device. Additionally, or alternatively, the path trace data may include an indication of the detected hops in the SD-WAN. In some instances, the path trace data may include an indication of the Internet Protocol addresses (IP addresses) associated with the hops. After the first network device has sent path traces and has collected path trace data, the first network device may be configured to send the path trace data to the SD-WAN controller.

At block 404, the process 400 may include sending, from the edge device and to a control plane, underlay path trace data. In some instances, the SD-WAN controller may use, or work in conjunction with, the SD-WAN analytic service in order to identify underlay attributes associated with the hops detected by the first network device. In some instances, the SD-WAN analytic service may be configured to analyze the path trace data, including time stamp data and/or geolocation data indicating the geolocation of the edge device to determine one or more attributes associated with the hops in the SD-WAN. In some instances, the SD-WAN analytic service may perform geolocation techniques to determine the geolocation of the hops of the SD-WAN. The SD-WAN analytic service may be configured to perform a geolocation lookup based on IP addresses included in the path trace data, and/or other types of path trace data, to determine the geolocation (e.g., coordinates, city, region, country, etc.) of the hops of the SD-WAN. Additionally, or alternatively, the SD-WAN analytic service may determine, using reverse ISP lookup techniques, the particular ISP associated with each hop. The SD-WAN analytic service may be configured to perform a reverse lookup based on IP addresses included in the path trace data, and/or or other types of path trace data, to determine the ISPs associated with the hops of the SD-WAN. By way of example, and not limitation, a first hop may be associated with an ISP XXX, a second hop may be associated with an IP YYY, a third hop may be associated with an ISP ZZZ, and so on.

The SD-WAN analytic service may also be configured to determine other types of attributes associated with the SD-WAN based on the path trace data (e.g., hot spots, high-risk regions, historical usage patterns, and/or the like). For instance, the SD-WAN analytic service may be configured to identify geographic locations, or regions, that may be high-risk for network traffic. In some examples, a particular region may be considered high-risk for the entity associated with the network manager. In some examples, a particular region may be considered high-risk for an entity (e.g., in terms of security, reliability, and/or availability), or may be considered high-risk based on regulations. As a non-limiting example, the SD-WAN analytic service may determine an attribute of a hop, where the attribute may include an indication that the hop is located in a particular region that is considered high-risk. Similarly, the SD-WAN analytic service may be configured to identify high-risk ISPs. In some examples, a particular ISP may be considered high-risk for an entity. As a non-limiting example, the SD-WAN analytic service may determine an attribute of hop, where the attribute may include an indication that the hop is associated with an ISP XXX that is considered high-risk for the entity associated with the network device.

At block 406, the process 400 may include receiving, from the control plane, a policy indicating segments of the underlay paths that are associated with an attribute for an entity associated with the edge device. For example, based on the attributes determined by the SD-WAN analytic service and/or attributes indicated by the policy data, the SD-WAN analytic service may be configured to send underlay policy data to be used by first network device in routing traffic through a path of the SD-WAN.

At block 408, the process 400 may include determining whether the attribute indicates that the segments of the underlay paths are to be avoided or included in a first underlay path. For instance, the underlay policy data may include an indication of attributes that are to be avoided and/or included when routing traffic through a path of the SD-WAN. Continuing from the example above, a hop of SD-WAN may be determined by the SD-WAN analytic service as being associated with an undesirable attribute, where the attribute indicates that the hop is located in Switzerland. Additionally, or alternatively, a hop of SD-WAN may be determined by the SD-WAN analytic service as being associated with an undesirable attribute, where the attribute indicates that the hop is associated with ISP YYY. At block 410, the process 400 may include in response to the attribute indicating that the segments are to be avoided, identifying the first underlay path for sending data on behalf of the entity associated with the edge device such that the segments of the underlay paths that are associated with the attribute are avoided. For example, the SD-WAN controller may receive policy data associated with the entity of the network manager, where the policy data may indicate desirable and/or undesirable attributes associated with the path through which the entity intends their traffic to traverse. For example, the policy data may indicate an intent to route traffic through a path that is compliant with a service level agreement (SLA) value, traverses through a hop in Canada, and/or traverses through ISP XXX. Additionally, or alternatively, the policy data may indicate an intent to route traffic through a path that is compliant with the SLA value, avoids traversing through a hop in Switzerland, and/or avoids traversing through ISP YYY. By way of example, and not limitation, a hop of SD-WAN may be determined by the SD-WAN analytic service as being associated with an undesirable attribute, where the attribute indicates that the hop is located in Switzerland. Additionally, or alternatively, a hop of SD-WAN may be determined by the SD-WAN analytic service as being associated with an undesirable attribute, where the attribute indicates that the hop is associated with ISP YYY. Additionally, or alternatively, the policy data may indicate an intent to generally route traffic through a path that avoids hotspots and/or high-risk regions.

At block 410, the process 400 may include in response to the attribute indicating that the segments are to be avoided, identifying the first underlay path for sending data on behalf of the entity associated with the edge device such that the segments of the underlay paths that are associated with the attribute are avoided.

At block 412, the process 400 may include in response to the attribute indicating that the segments are to be included, identifying the first underlay path for sending data on behalf of the entity associated with the edge device such that the segments of the underlay paths that are associated with the attribute are included.

At block 414, the process 400 may include routing data on behalf of the entity through the first underlay path. For example, based on the undesirable attribute(s) that may be indicated by the underlay policy data, the first network device may route traffic through a path that may not include the hop associated with undesirable attribute(s). Additionally, or alternatively, the underlay policy data may be updated by the SD-WAN analytic service in response to changes in network conditions indicated by path trace data (e.g., the SD-WAN analytic service determines that, based at least in part on the path trace data, a hop that was previously high-risk is no longer high-risk).

Additionally, or alternatively, the process 400 may include, wherein the policy is a first policy and the attribute is a first undesirable attribute, receiving, from the control plane, a second policy indicating segments of the underlay paths that are associated with a second attribute for the entity associated with the edge device. Additionally, or alternatively, the process 400 may include determining whether the second attribute indicates that the segments of the underlay paths are to be avoided or included in a second underlay path, and in response to the second attribute indicating that the segments are to be avoided, identifying the second underlay path for sending data on behalf of the entity associated with the edge device such that the segments of the underlay paths that are associated with the second attribute are avoided, or in response to the second attribute indicating that the segments are to be included, identifying the second underlay path for sending data on behalf of the entity associated with the edge device such that the segments of the underlay paths that are associated with the second attribute are included. Additionally, or alternatively, the process 400 may include routing data on behalf of the entity through the second underlay path instead of the first underlay path.

Additionally, or alternatively, the process 400 may include the attribute including a geographic location, a particular internet service provider, a network outage, and/or a network hotspot.

Additionally, or alternatively, the process 400 may include wherein enabling the path trace further includes sending, from the edge device, path traces over the underlay paths and receiving underlay path trace data indicating the segments of the underlay paths.

Additionally, or alternatively, the process 400 may include, wherein the policy is a first policy, receiving, from the control plane, a second policy indicating segments of the underlay paths that include an undesirable attribute for the entity associated with the edge device, identifying a second underlay path for sending data on behalf of the entity associated with the edge device such that the segments of the underlay paths that are associated with the undesirable attribute are avoided, and routing data on behalf of the entity through the second underlay path.

Additionally, or alternatively, the process 400 may include wherein the policy is based at least in part on an entity input indicating the attribute for the entity associated with the edge device.

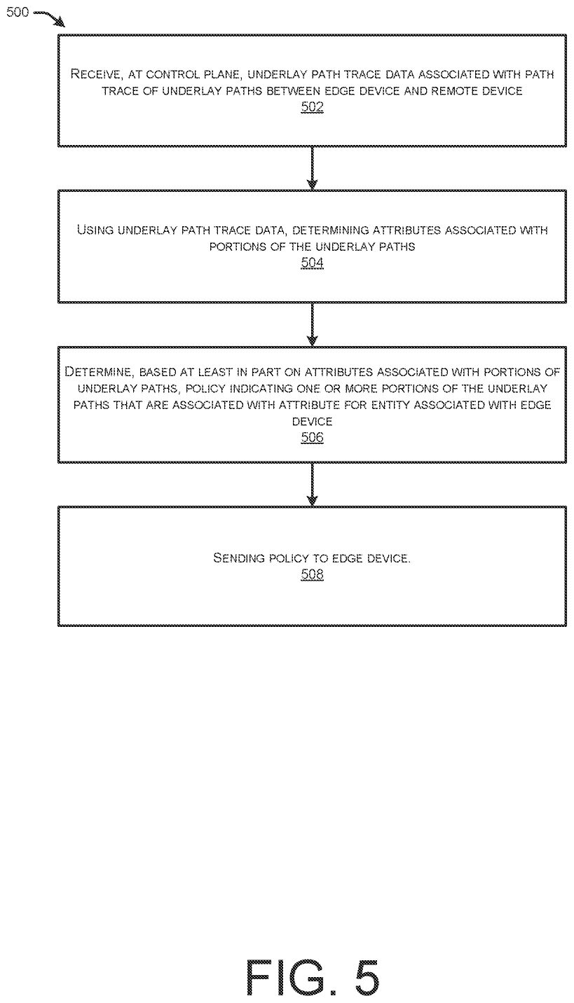

FIG. 5 illustrates a flow diagram of an example method for using SD-WAN underlay attributes for underlay-aware routing decisions, according to at least some examples. The techniques may be applied by a system comprising one or more processors, and one or more non-transitory computer-readable media storing computer-executable instructions that, when executed by the one or more processors, cause the one or more processors to perform operations of process 500.

At block 502, the process 500 may include receiving, at a control plane, underlay path trace data associated with a path trace of underlay paths between an edge device and a remote device. For example, a first network device may collect path trace data associated with the SD-WAN that may indicate a detection of one or more hops included in the multiple paths. For example, the first network device may be configured to send path trace(s) (e.g., probes) periodically or continuously to collect path trace data associated with the multiple paths and their respective hops (e.g., routers, intermediary devices, etc.) between the first network device and/or network device. In some instances, the path trace data may include data such as round-trip-time (RTT), packet loss, latency, available bandwidth, jitter, time-to-live (TTL), and/or other characteristics indicative of network performance. The path trace data may be timestamped based on when the path trace data was generated, and the first network device may send the path trace data, timestamp data, and/or geolocation data indicating a geolocation of the first network device. Additionally, or alternatively, the path trace data may include an indication of the detected hops in the SD-WAN. In some instances, the path trace data may include an indication of the Internet Protocol addresses (IP addresses) associated with the hops. After the first network device has sent path traces and has collected path trace data, the first network device may be configured to send the path trace data to the SD-WAN controller.

At block 504, the process 500 may include using the underlay path trace data, determining attributes associated with portions of the underlay paths. In some instances, the SD-WAN controller may use, or work in conjunction with, the SD-WAN analytic service in order to identify underlay attributes associated with the hops detected by the first network device. In some instances, the SD-WAN analytic service may be configured to analyze the path trace data, including time stamp data and/or geolocation data indicating the geolocation of the edge device to determine one or more attributes associated with the hops in the SD-WAN. In some instances, the SD-WAN analytic service may perform geolocation techniques to determine the geolocation of the hops of the SD-WAN. The SD-WAN analytic service may be configured to perform a geolocation lookup based on IP addresses included in the path trace data, and/or other types of path trace data, to determine the geolocation (e.g., coordinates, city, region, country, etc.) of the hops of the SD-WAN. Additionally, or alternatively, the SD-WAN analytic service may determine, using reverse ISP lookup techniques, the particular ISP associated with each hop. The SD-WAN analytic service may be configured to perform a reverse lookup based on IP addresses included in the path trace data, and/or or other types of path trace data, to determine the ISPs associated with the hops of the SD-WAN. By way of example, and not limitation, a first hop may be associated with an ISP XXX, a second hop may be associated with an IP YYY, a third hop may be associated with an ISP ZZZ, and so on.

The SD-WAN analytic service may also be configured to determine other types of attributes associated with the SD-WAN based on the path trace data (e.g., hot spots, high-risk regions, historical usage patterns, and/or the like). For instance, the SD-WAN analytic service may be configured to identify geographic locations, or regions, that may be high-risk for network traffic. In some examples, a particular region may be considered high-risk for the entity associated with the network manager. In some examples, a particular region may be considered high-risk for an entity (e.g., in terms of security, reliability, and/or availability), or may be considered high-risk based on regulations. As a non-limiting example, the SD-WAN analytic service may determine an attribute of hop, where the attribute may include an indication that the hop is located in a particular region that is considered high-risk. Similarly, the SD-WAN analytic service may be configured to identify high-risk ISPs. In some examples, a particular ISP may be considered high-risk for an entity. As a non-limiting example, the SD-WAN analytic service may determine an attribute of hop, where the attribute may include an indication that the hop is associated with an ISP XXX that is considered high-risk for the entity associated with the network manager.

In some instances, the SD-WAN controller may be associated with and/or communicatively coupled to a network manager such that the SD-WAN controller may receive policy data associated with an entity. This way, the SD-WAN controller may receive policy data associated with the entity, where the policy data may indicate desirable and/or undesirable attributes associated with the path through which the entity intends their traffic to traverse. For example, the policy data may indicate an intent to route traffic through a path that is compliant with a service level agreement (SLA) value, traverses through a hop in Canada, and/or traverses through ISP XXX. Additionally, or alternatively, the policy data may indicate an intent to route traffic through a path that is compliant with the SLA value, avoids traversing through a hop in Switzerland, and/or avoids traversing through ISP YYY. By way of example, and not limitation, a hop of SD-WAN may be determined by the SD-WAN analytic service as being associated with an undesirable attribute, where the attribute indicates that the hop is located in Switzerland. Additionally, or alternatively, a hop of SD-WAN may be determined by the SD-WAN analytic service as being associated with an undesirable attribute, where the attribute indicates that the hop is associated with ISP YYY. Additionally, or alternatively, the policy data may indicate an intent to generally route traffic through a path that avoids hotspots and/or high-risk regions.

At block 506, the process 500 may include determining, based at least in part on the attributes associated with portions of the underlay paths, a policy indicating one or more portions of the underlay paths that are associated with an attribute for an entity associated with the edge device. For example, based on the attributes determined by the SD-WAN analytic service and/or attributes indicated by the policy data, the SD-WAN analytic service may be configured to generate and/or send underlay policy data to be used by first network device in routing traffic through a path of the SD-WAN. For instance, the underlay policy data may include an indication of attributes that are to be avoided when routing traffic through a path of the SD-WAN. Continuing from the example above, a hop of SD-WAN may be determined by the SD-WAN analytic service as being associated with an undesirable attribute, where the attribute indicates that the hop is located in Switzerland. Additionally, or alternatively, a hop of SD-WAN may be determined by the SD-WAN analytic service as being associated with an undesirable attribute, where the attribute indicates that the hop is associated with ISP YYY.

At block 508, the process 500 may include sending the policy to the edge device. For example, based on the undesirable attribute(s) that may be indicated by the underlay policy data, the first network device may route traffic through a path that may not include the hop associated with undesirable attribute(s). Additionally, or alternatively, the underlay policy data may be updated by the SD-WAN analytic service in response to changes in network conditions indicated by path trace data (e.g., the SD-WAN analytic service determines that, based at least in part on the path trace data, a hop that was previously high-risk is no longer high-risk).

Additionally, or alternatively, the process 500 may include wherein the policy is a first policy and the attribute is a first undesirable attribute, determining, based at least in part on the attributes associated with portions of the underlay paths, a second policy indicating one or more portions of the underlay paths that are associated with a second attribute for the entity associated with the edge device, and sending the second policy to the edge device.

Additionally, or alternatively, the process 500 may include wherein the attributes associated with portions of the underlay paths include at least one of a geographic location and/or a particular network service provider.

Additionally, or alternatively, the process 500 may include wherein the attribute is an undesirable attribute for the entity associated with the edge device, the undesirable attribute including a high-risk geographic location, a high-risk internet service provider, a network outage, and/or a network hotspot.

Additionally, or alternatively, the process 500 may include, wherein the policy is a first policy, determining, based at least in part on the attributes associated with portions of the underlay paths, a second policy indicating one or more portions of the underlay paths that are associated with a desirable attribute for the entity associated with the edge device, and sending the second policy to the edge device.

Additionally, or alternatively, the process 500 may include receiving, from the entity associated with the edge device, entity input indicating the attribute for the entity associated with the edge device, and determining, based at least in part on the attributes associated with portions of the underlay paths and the entity input, the policy indicating one or more portions of the underlay paths that are associated with the attribute for the entity associated with the edge device.

Additionally, or alternatively, the process 500 may include identifying, based on the path trace data, Internet Protocol addresses (IP addresses) associated with the underlay paths, determining, based on the IP addresses, geographic locations associated with the portions of the underlay paths, determining that a geographic location is an undesirable geographic location, and determining, based on the geographic location being the undesirable geographic location, the policy indicating a portion of the underlay paths that is associated with the undesirable geographic location.

Additionally, or alternatively, the process 500 may include identifying, based on the path trace data, Internet Protocol addresses (IP addresses) associated with the underlay path, determining, based on the IP addresses, internet service providers (ISPs) associated with the portions of the underlay paths, determining that an ISP is an undesirable ISP, and determining, based on the ISP being the undesirable ISP, the policy indicating a portion of the underlay paths that is associated with the undesirable ISP.

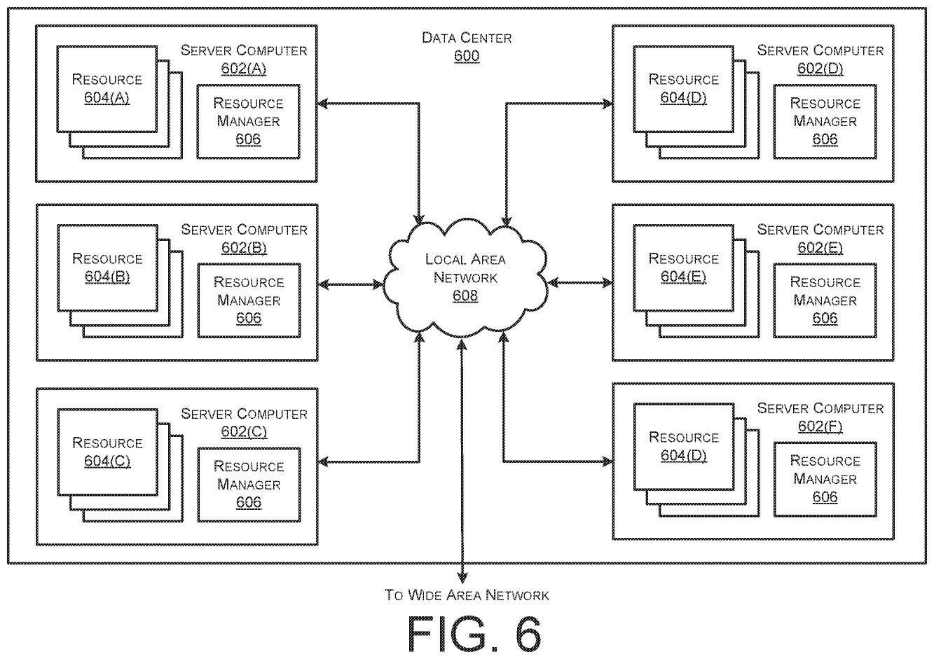

FIG. 6 is a computing system diagram illustrating a configuration for a data center 600 that can be utilized to implement aspects of the technologies disclosed herein. In one example, the data center 600 may be used to support the SD-WAN analytic service 108 and/or the SD-WAN 114. The example data center 600 shown in FIG. 6 includes several server computers 602A-602F (which might be referred to herein singularly as “a server computer 602” or in the plural as “the server computers 602”) for providing computing resources. In some examples, the resources and/or server computers 602 may include, or correspond to, the any type of networked device described herein. Although described as servers, the server computers 602 may comprise any type of networked device, such as servers, switches, routers, hubs, bridges, gateways, modems, repeaters, access points, etc.

The server computers 602 can be standard tower, rack-mount, or blade server computers configured appropriately for providing computing resources. In some examples, the server computers 602 may provide computing resources 604 including data processing resources such as VM instances or hardware computing systems, database clusters, computing clusters, storage clusters, data storage resources, database resources, networking resources, and others. Some of the servers 602 can also be configured to execute a resource manager 606 capable of instantiating and/or managing the computing resources. In the case of VM instances, for example, the resource manager 606 can be a hypervisor or another type of program configured to enable the execution of multiple VM instances on a single server computer 602. Server computers 602 in the data center 600 can also be configured to provide network services and other types of services. In one example, server computers 602 may be used to support the SD-WAN analytic service 108 and/or the cloud service 106.

In the example data center 600 shown in FIG. 6, an appropriate LAN 608 is also utilized to interconnect the server computers 602A-602F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 600, between each of the server computers 602A-602F in each data center 600, and, potentially, between computing resources in each of the server computers 602. It should be appreciated that the configuration of the data center 600 described with reference to FIG. 6 is merely illustrative and that other implementations can be utilized.

In some examples, the server computers 602 may each execute one or more application containers and/or virtual machines to perform techniques described herein.

In some instances, the data center 600 may provide computing resources, like application containers, VM instances, and storage, on a permanent or an as-needed basis. Among other types of functionality, the computing resources provided by a cloud computing network may be utilized to implement the various services and techniques described above. The computing resources 604 provided by the cloud computing network can include various types of computing resources, such as data processing resources like application containers and VM instances, data storage resources, networking resources, data communication resources, network services, and the like.

Each type of computing resource 604 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 604 not mentioned specifically herein.

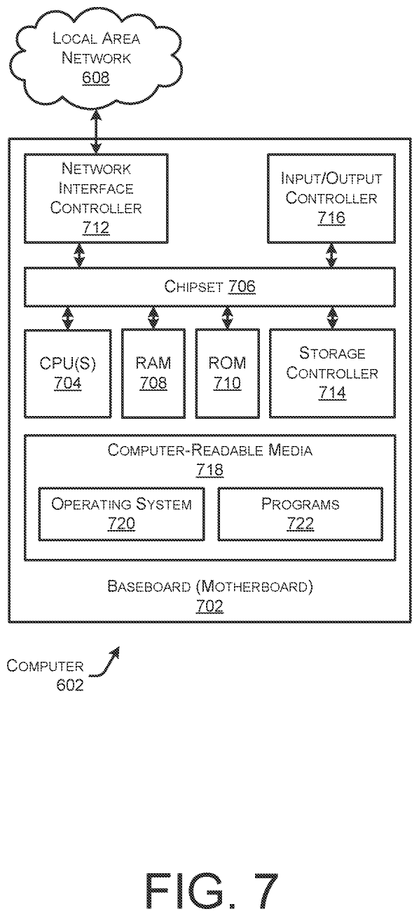

The computing resources 604 provided by a cloud computing network may be enabled in one embodiment by one or more data centers 600 (which might be referred to herein singularly as “a data center 600” or in the plural as “the data centers 600”). The data centers 600 are facilities utilized to house and operate computer systems and associated components. The data centers 600 typically include redundant and backup power, communications, cooling, and security systems. The data centers 600 can also be located in geographically disparate locations. One illustrative embodiment for a data center 600 that can be utilized to implement the technologies disclosed herein will be described below with regard to FIG. 7.

FIG. 7 shows an example computer architecture for a server computer 602 capable of executing program components for implementing the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein. The server computer 602 may, in some examples, correspond to a physical server and may comprise networked devices such as servers, switches, routers, hubs, bridges, gateways, modems, repeaters, access points, etc.

The computer 602 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 602.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 602. The chipset 706 can further provide an interface to a computer-readable storage medium such as a read-only memory (“ROM”) 710 or non-volatile RAM (“NVRAM”) for storing basic routines that help to startup the computer 602 and to transfer information between the various components and devices. The ROM 710 or NVRAM can also store other software components necessary for the operation of the computer 602 in accordance with the configurations described herein.

The computer 602 can operate in a networked environment using logical connections to remote computing devices and computer systems through a network, such as the network 608. The chipset 706 can include functionality for providing network connectivity through a NIC 712, such as a gigabit Ethernet adapter. The NIC 712 is capable of connecting the computer 602 to other computing devices over the network 608. It should be appreciated that multiple NICs 712 can be present in the computer 602, connecting the computer to other types of networks and remote computer systems.

The computer 602 can be connected to a storage device 718 that provides non-volatile storage for the computer. The storage device 718 can store an operating system 720, programs 722, and data, which have been described in greater detail herein. The storage device 718 can be connected to the computer 602 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 602 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 602 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 602 can further read information from the storage device 718 by detecting the physical states or characteristics of one or more particular locations within the physical storage units.

In addition to the mass storage device 718 described above, the computer 602 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 602. In some examples, the operations performed by devices in the cloud service 106, and or any components included therein, may be supported by one or more devices similar to computer 602. Stated otherwise, some or all of the operations performed by the cloud service 106, and or any components included therein, may be performed by one or more computer devices 602 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 602. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 602.

In one embodiment, the storage device 718 or other computer-readable storage media is encoded with computer-executable instructions which, when loaded into the computer 602, transform the computer from a general-purpose computing system into a special-purpose computer capable of implementing the embodiments described herein. These computer-executable instructions transform the computer 602 by specifying how the CPUs 704 transition between states, as described above. According to one embodiment, the computer 602 has access to computer-readable storage media storing computer-executable instructions which, when executed by the computer 602, perform the various processes described above with regard to FIGS. 1-6. The computer 602 can also include computer-readable storage media having instructions stored thereupon for performing any of the other computer-implemented operations described herein.

The computer 602 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computer 602 might not include all of the components shown in FIG. 7, can include other components that are not explicitly shown in FIG. 7, or might utilize an architecture completely different than that shown in FIG. 7.

As described herein, the computer 602 may comprise one or more of a router, load balancer, and/or server. The computer 602 may include one or more hardware processors 704 (processors) configured to execute one or more stored instructions. The processor(s) 704 may comprise one or more cores. Further, the computer 602 may include one or more network interfaces configured to provide communications between the computer 602 and other devices, such as the communications described herein as being performed by the router, load balancer, and/or server. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 722 may comprise any type of programs or processes to perform the techniques described in this disclosure for prioritizing the scanning of incoming messages based on an account status and/or an activity pattern associated with the account receiving the message. That is, the computer 602 may comprise any one of the routers, load balancers, and/or servers. The programs 722 may comprise any type of program that cause the computer 602 to perform techniques for communicating with other devices using any type of protocol or standard usable for determining connectivity.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method performed at least in part by an edge device of a software-defined wide area network (SD-WAN), the method comprising:
enabling, at the edge device, a path trace of underlay paths between the edge device and a remote device,
sending, from the edge device and to a control plane, underlay path trace data;
receiving, from the control plane, a policy indicating segments of the underlay paths that are associated with an attribute for an entity associated with the edge device;
determining whether the attribute indicates that the segments of the underlay paths are to be avoided or included in a first underlay path, wherein:
in response to the attribute indicating that the segments are to be avoided, identifying the first underlay path for sending data on behalf of the entity associated with the edge device such that the segments of the underlay paths that are associated with the attribute are avoided; or
in response to the attribute indicating that the segments are to be included, identifying the first underlay path for sending data on behalf of the entity associated with the edge device such that the segments of the underlay paths that are associated with the attribute are included; and
routing data on behalf of the entity through the first underlay path.

2. The method of claim 1, wherein the policy is a first policy and the attribute is a first attribute, the method further comprising:
receiving, from the control plane, a second policy indicating segments of the underlay paths that are associated with a second attribute for the entity associated with the edge device;
determining whether the second attribute indicates that the segments of the underlay paths are to be avoided or included in a second underlay path, wherein:
in response to the second attribute indicating that the segments are to be avoided, identifying the second underlay path for sending data on behalf of the entity associated with the edge device such that the segments of the underlay paths that are associated with the second attribute are avoided; or
in response to the second attribute indicating that the segments are to be included, identifying the second underlay path for sending data on behalf of the entity associated with the edge device such that the segments of the underlay paths that are associated with the second attribute are included; and
routing data on behalf of the entity through the second underlay path instead of the first underlay path.

3. The method of claim 1, the attribute including:
a geographic location;
a particular internet service provider;
a network outage; or
a network hotspot.

4. The method of claim 1, wherein enabling the path trace further includes:
sending, from the edge device, path traces over the underlay paths; and
receiving underlay path trace data indicating the segments of the underlay paths.

5. The method of claim 1, wherein the policy is a first policy, the method further comprising:
receiving, from the control plane, a second policy indicating segments of the underlay paths that include an undesirable attribute for the entity associated with the edge device;
identifying a second underlay path for sending data on behalf of the entity associated with the edge device such that the segments of the underlay paths that are associated with the undesirable attribute are avoided; and
routing data on behalf of the entity through the second underlay path.

6. The method of claim 1, wherein the policy is based at least in part on an entity input indicating the attribute for the entity associated with the edge device.

7. A system comprising:
one or more processors; and
one or more computer-readable media storing computer-executable instructions that, when executed by the one or more processors, cause the one or more processors to perform operations comprising:
enabling, at an edge device, a path trace of underlay paths between the edge device and a remote device,
sending, from the edge device and to a control plane, underlay path trace data;
receiving, from the control plane, a policy indicating segments of the underlay paths that are associated with an attribute for an entity associated with the edge device;
determining whether the attribute indicates that the segments of the underlay paths are to be avoided or included in a first underlay path, wherein:
in response to the attribute indicating that the segments are to be avoided, identifying the first underlay path for sending data on behalf of the entity associated with the edge device such that the segments of the underlay paths; or
in response to the attribute indicating that the segments are to be included, identifying the first underlay path for sending data on behalf of the entity associated with the edge device such that the segments of the underlay paths that are associated with the attribute are included; and
routing data on behalf of the entity through the first underlay path.

8. The system of claim 7, wherein the policy is a first policy and the attribute is a first attribute, the operations further comprising:
receiving, from the control plane, a second policy indicating segments of the underlay paths that are associated with a second attribute for the entity associated with the edge device;
determining whether the second attribute indicates that the segments of the underlay paths are to be avoided or included in a second underlay path;
in response to the second attribute indicating that the segments are to be avoided, identifying the second underlay path for sending data on behalf of the entity associated with the edge device such that the segments of the underlay paths that are associated with the second attribute are included; and
routing data on behalf of the entity through the second underlay path instead of the first underlay path.

9. The system of claim 7, the attribute including:
a geographic location;
a particular internet service provider;
a network outage; or
a network hotspot.

10. The system of claim 7, wherein enabling the path trace further includes:
sending, from the edge device, path traces over the underlay paths; and
receiving underlay path trace data indicating the segments of the underlay paths.

11. The system of claim 7, wherein the policy is a first policy, the operations further comprising:
receiving, from the control plane, a second policy indicating segments of the underlay paths that include an undesirable attribute for the entity associated with the edge device;
identifying a second underlay path for sending data on behalf of the entity associated with the edge device such that the segments of the underlay paths that are associated with the undesirable attribute are avoided; and
routing data on behalf of the entity through the second underlay path.

12. The system of claim 7, wherein the policy is based at least in part on an entity input indicating the attribute for the entity associated with the edge device.

13. One or more non-transitory computer-readable media storing instructions that, when executed, cause one or more processors to perform operations comprising:
receiving, at a control plane, underlay path trace data associated with a path trace of underlay paths between an edge device and a remote device;
using the underlay path trace data, determining attributes associated with portions of the underlay paths;
determining, based at least in part on the attributes associated with portions of the underlay paths, a policy indicating one or more portions of the underlay paths that are associated with an attribute for an entity associated with the edge device; and
sending the policy to the edge device.

14. The one or more non-transitory computer-readable media of claim 13, wherein the policy is a first policy and the attribute is a first attribute, the operations further comprising:
determining, based at least in part on the attributes associated with portions of the underlay paths, a second policy indicating one or more portions of the underlay paths that are associated with a second attribute for the entity associated with the edge device; and
sending the second policy to the edge device.

15. The one or more non-transitory computer-readable media of claim 13, wherein the attributes associated with portions of the underlay paths include at least one of:
a geographic location; or
a particular network service provider.

16. The one or more non-transitory computer-readable media of claim 13, wherein the attribute is an undesirable attribute for the entity associated with the edge device, the undesirable attribute including:
a high-risk geographic location;
a high-risk internet service provider;
a network outage; or
a network hotspot.

17. The one or more non-transitory computer-readable media of claim 13, wherein the policy is a first policy, the operations further comprising:
determining, based at least in part on the attributes associated with portions of the underlay paths, a second policy indicating one or more portions of the underlay paths that are associated with a desirable attribute for the entity associated with the edge device; and
sending the second policy to the edge device.

18. The one or more non-transitory computer-readable media of claim 13, the operations further comprising:
receiving, from the entity associated with the edge device, entity input indicating the attribute for the entity associated with the edge device; and
determining, based at least in part on the attributes associated with portions of the underlay paths and the entity input, the policy indicating one or more portions of the underlay paths that are associated with the attribute for the entity associated with the edge device.

19. The one or more non-transitory computer-readable media of claim 13, the operations further comprising:
identifying, based on the underlay path trace data, Internet Protocol addresses (IP addresses) associated with the underlay paths;
determining, based on the IP addresses, geographic locations associated with the portions of the underlay paths;
determining that a geographic location is an undesirable geographic location; and
determining, based on the geographic location being the undesirable geographic location, the policy indicating a portion of the underlay paths that is associated with the undesirable geographic location.

20. The one or more non-transitory computer-readable media of claim 13, the operations further comprising:
identifying, based on the underlay path trace data, Internet Protocol addresses (IP addresses) associated with the underlay paths;
determining, based on the IP addresses, internet service providers (ISPs) associated with the portions of the underlay paths;
determining that an ISP is an undesirable ISP; and
determining, based on the ISP being the undesirable ISP, the policy indicating a portion of the underlay paths that is associated with the undesirable ISP.
